(19) United States
(12) Patent Application Publication
(10) Pub. No.: US 2021/0295564 A1
(43) Pub. Date: Sep. 23, 2021

(54) CENTER-TO-EDGE PROGRESSIVE IMAGE ENCODING/DECODING METHOD AND APPARATUS

(71) Applicant: INDUSTRY-ACADEMIA COOPERATION GROUP OF SEJONG UNIVERSITY, Seoul (KR)

(72) Inventor: Oh Jin Kwon, Hanam-si (KR)

(21) Appl. No.: 17/266,562

(22) PCT Filed: Feb. 10, 2020
(86) PCT No.: PCT/KR2020/001831

§ 371 Date: Feb. 5, 2021

(30) Foreign Application Priority Data
Feb. 20, 2019 (KR) 10-2019-0019853

(51) Int. Cl. G06T 9/00; H04N 19/103; H04N 19/176

(52) U.S. Cl. CPC G06T 9/00; H04N 19/176; H04N 19/103

(57) ABSTRACT

Disclosed are a progressive image encoding method and a decoding method corresponding thereto. The encoding method comprises the steps of: with respect to an image, acquiring information relating to a central area; selecting an initial block from at least one block included in the central area; determining an encoding path for a plurality of blocks included in the image, according to a center-to-edge sequence from the initial block; and encoding the image on the basis of the encoding path.

### CROSS-REFERENCE TO RELATED APPLICATION

The present application is U.S. National Phase application under 35 U.S.C. § 371 of an International application No. PCT/KR2020/001831 filed on Feb. 10, 2020, which is based on and claims the benefit of convention priority to Korean Patent Application No. 10-2019-0019853, filed on Feb. 20, 2019 in the Korean Intellectual Property Office, the disclosure of which is incorporated by reference herein in its entirety.

### TECHNICAL FIELD

The present disclosure relates to a method and device for center-to-edge progressive encoding and decoding of a picture and, more particularly, to a method and device for encoding and decoding a picture in an order from a center of the picture to an outer side of the picture starting from at least one block included in the picture.

### BACKGROUND

Pictures including still pictures and moving pictures have enormous data sizes, and storing and transmission of them requires much costs. Accordingly, the picture data is generally compressed before it is stored in a storage or transmitted to another device in order to reduce the costs. Examples of standards for compressing the picture data include Joint Photographic Experts Group (JPEG) compression scheme which is an international standard for still images and a Moving Picture Experts Group (MPEG) compression scheme which is an international standard for moving pictures.

However, the compression of the picture according to the international standard causes a deterioration in a picture quality depending on a compression ratio. Thus, the picture quality and the compression ratio are still at issue, and researches are being conducted in universities and industries to reduce the degradation of picture qualities and achieve a higher compression ratio.

As resolutions of cameras and display devices are getting higher, the sizes of images are increasing continuously. As a result, despite the continuous development of image compression technologies, delays caused in transmissions of the images through a network has not been resolved. Therefore, there is a growing need for a high-efficiency image compression technology as well as a human-friendly progressive image coding technology.

### SUMMARY

Provided is a method of center-to-edge progressive encoding and decoding of a picture.

Provided is a device for center-to-edge progressive encoding and decoding of a picture.

According to an aspect of an exemplary embodiment, a method of progressively encoding a picture includes: obtaining information regarding a central region of the picture; selecting an initial block from at least one block included in the central region; determining a coding path for encoding a plurality of blocks included in the picture in a center-to-edge order starting from the initial block; and encoding the picture on the basis of the coding path.

The central region may include a region of the picture corresponding to a line of sight of a user or a central region of the picture having a predetermined size.

The operation of selecting the initial block from the at least one block included in the central region may include: selecting, as the initial block, a block located closest to a center of the central region among the at least one block included in the central region.

The operation of determining the coding path for the plurality of blocks included in the picture in the center-to-edge order starting from the initial block may include: determining the coding path for the plurality of blocks included in the picture along a clockwise or counterclockwise spiral path starting from the initial block.

The operation of determining the coding path for the plurality of blocks included in the picture along the clockwise or counterclockwise spiral path starting from the initial block may include: when there is at least one remaining block which is not included in the coding path determined along the spiral path among the plurality of blocks, determining the coding path for the at least one remaining block starting from a last block included in the coding path.

The operation of determining the coding path for the at least one remaining block may include: determining the coding path for the at least one remaining block to minimize a number of discontinuity in the coding path between adjacent blocks among the at least one remaining block.

According to another aspect of an exemplary embodiment, a device for progressively encoding a picture includes: a processor; and a memory storing at least one instruction to be executed by the processor. The at least one instruction when executed by the processor causes the processor to: obtain information regarding a central region of the picture; select an initial block from at least one block included in the central region; determine a coding path for encoding a plurality of blocks included in the picture in a center-to-edge order starting from the initial block; and encode the picture on the basis of the coding path.

The at least one instruction may further include an instruction causing the processor to: wherein the central region comprises a region of the picture corresponding to a line of sight of a user or a central region of the picture having a predetermined size.

The at least one instruction may further include an instruction causing the processor to: select, as the initial block, a block located closest to a center of the central region among the at least one block included in the central region.

The at least one instruction may further include an instruction causing the processor to: determine the coding path for the plurality of blocks included in the picture along a clockwise or counterclockwise spiral path starting from the initial block.

The at least one instruction may further include an instruction causing the processor to: when there is at least one remaining block which is not included in the coding path determined along the spiral path among the plurality of blocks, determining the coding path for the at least one remaining block starting from a last block included in the coding path.

The at least one instruction may further include an instruction causing the processor to: determine the coding path for the at least one remaining block to minimize a number of discontinuity in the coding path between adjacent blocks among the at least one remaining block.

The present disclosure makes it possible to first decode a region corresponding to a user's viewport among entire regions of a high-resolution picture.

The present disclosure can minimize the inconvenience of the user due to the transmission delay by first decoding the region corresponding to the user's viewport.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of a JPEG picture encoding device;

FIG. 2 illustrates a typical block ordering scheme;

FIG. 3 illustrates a block ordering scheme according to an embodiment of the present disclosure;

FIGS. 4A and 4B illustrate block ordering schemes for a rectangular picture block according to embodiments of the present disclosure;

FIG. 5 illustrates a block ordering scheme for a picture having two regions-of-interest (ROIs) according to an embodiment of the present disclosure;

FIG. 6 illustrates a block ordering scheme for a 360-degree picture according to an embodiment of the present disclosure;

FIG. 7 illustrates a block ordering scheme for a moving picture according to an embodiment of the present disclosure;

FIG. 8 is a block diagram of a picture encoding device according to an embodiment of the present disclosure; and

FIG. 9 is a flowchart showing a picture encoding method according to an embodiment of the present disclosure.

The drawings described herein are for illustration purposes only and are not intended to limit the scope of the present disclosure in any way.

### DETAILED DESCRIPTION

Various modifications may be made in the present disclosure and various embodiments may be implemented and thus certain embodiments are illustrated in the accompanying drawings and described in the detailed description. However, it should be understood that the present disclosure is not limited to particular embodiments and includes all modifications, equivalents, and alternatives falling within the idea and scope of the present disclosure. In describing each drawing, similar reference numerals have been used for similar components.

Terms such as first, second, A, and B may be used to describe various components but the components should not be limited by the terms. The terms are only used to distinguish one component from another. For example, a first component may be referred to as a second component without departing from the scope of the present disclosure, and similarly, a second component may also be referred to as a first component. The term “and/or” includes a combination of a plurality of related items described herein or any one of the plurality of related items.

When a component is referred to as being “coupled to” or “connected to” another component, it should be understood that the component may be directly coupled to or connected to the other component but another component may be interposed therebetween. In contrast, when a component is referred to as being “directly coupled to” or “directly connected” to another component, it should be understood that no component is interposed therebetween.

The terms used in this application are only used to describe certain embodiments and are not intended to limit the present disclosure. As used herein, the singular expressions are intended to include plural forms as well, unless the context clearly dictates otherwise. It should be understood that the terms “comprise” and/or “comprising”, when used herein, specify the presence of stated features, integers, steps, operations, elements, components, or a combination thereof but do not preclude the presence or addition of one or more features, integers, steps, operations, elements, components, or a combination thereof.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanying drawings. In describing the present disclosure, in order to facilitate an overall understanding thereof, the same components are assigned the same reference numerals in the drawings and are not redundantly described here. Hereinafter, embodiments of the present disclosure will be described in detail with reference to the accompanying drawings.

An encoding and decoding of a picture performed by changing a block ordering according to an embodiment of the present disclosure is applicable not only to a compression method for still pictures but also to a compression method for videos or moving pictures.

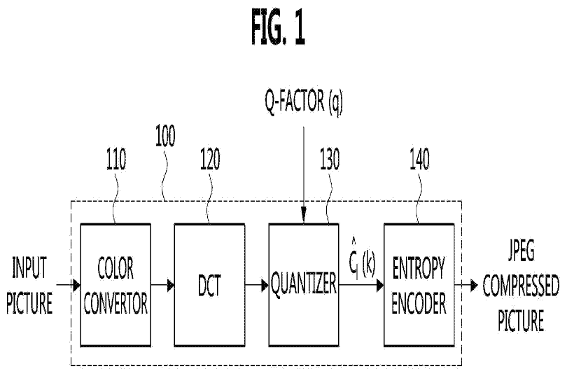

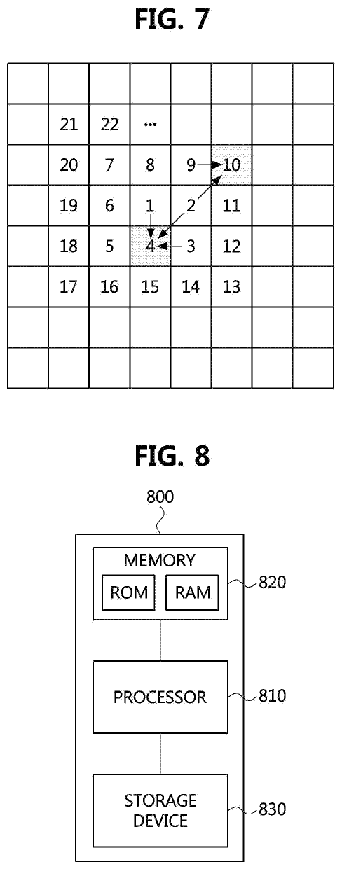

For convenience of explanation, embodiments of the present disclosure based on the JPEG compression method for still pictures will be described with reference to FIGS. 1-6, and additional configurations features applicable to the compression of videos or moving pictures will described with reference to FIG. 7.

FIG. 1 is a block diagram of a Joint Photographic Experts Group (JPEG) picture encoding device.

Referring to FIG. 1, a JPEG picture encoding device 100 may compress an input picture into a JPEG format to output a JPEG compressed picture and may be referred to as a JPEG encoder. The JPEG picture encoding device 100 may generally include a color convertor 110, a discrete cosine transform (DCT) unit 120, a quantizer 130, and an entropy encoder 140.

The color converter 110 may convert a color space of a picture from one expressed by red-green-blue (RGB) values into another one expressed by YCbCr values. Here, ‘Y’ may denote a luminance component, and ‘Cb’ and ‘Cr’ may denote blue-difference and red-difference chroma components, respectively. The Cb-component and Cr-component may be selectively subsampled. A sampling format for the YCbCr signal or the subsampling format for the chroma difference components may be one of 4:4:4, 4:2:2, and 4:2:0.

The DCT unit 120 may perform block-based DCT operations on picture data expressed in the YCbCr color space. The block-based DCT operations may be performed on each of the Y, Cb, and Cr components and may be performed on each block having a size of 8×8 pixels. Here, the DCT operation is one of methods commonly used for describing a picture in a frequency domain. In detail, the DCT operation converts the picture data in a spatial domain into the picture data in the frequency domain using cosine bases and yields DCT coefficients as a result. The DCT coefficients may include a direct current (DC) coefficient (i.e., average component coefficient) and alternating current (AC) coefficients (i.e., high-frequency component coefficients), and the DCT coefficients may be re-arranged into a one-dimensional vector by a zigzag ordering.

The quantizer 130 may receive the DCT coefficients from the DCT unit 120 to map each of the coefficients to a discrete value to obtain quantized DCT coefficients. The quantization performed by the quantizer 130 may cause a lossy compression, and each of contiguous or large amounts of input data may be mapped into a few discrete symbols after the quantization. A compression ratio may be controlled by an input parameter referred to as a quality factor (Q-factor). The Q-factor may be referred to as a picture quality factor or a quantization parameter, but the present disclosure is not limited thereto.

In FIG. 1, Ĉₗ(k) may denote a k-th quantized DCT coefficient in an l-th block among all the 8×8 blocks of the input picture. The one-dimensional index ‘l’ may be used to indicate a block in a two-dimensional space. The index ‘l’ may be an integer greater than or equal to zero and less than ‘L’, where ‘L’ may be a total number of 8×8 blocks in the input picture. Another index ‘k’ may be an integer greater than or equal to zero and less than or equal to 63. The coefficient Ĉₗ(k) may be referred to as the DC coefficient in the case that ‘k’ is zero, while the coefficient Ĉₗ(k) may be referred to as the AC coefficient in the case that ‘k’ is not zero.

The entropy encoder 140 may receive the quantized DCT coefficients from the quantizer 130 and perform an entropy encoding for the quantized DCT coefficients to obtain a compressed picture of a JPEG format. The entropy coding performed by the entropy encoder 140 may correspond to a lossless compression, and may minimize an amount of data representing encoded data by adaptively adjusting a length of a symbol according to a probability of occurrence of the symbol.

Although not shown in FIG. 1, a JPEG picture decoding device, which may be provided to correspond to the JPEG picture encoding device 100, may perform a reverse function or operation of the function or operation of the picture encoding device to decode a JPEG compressed picture and obtain an output picture. The JPEG picture decoding device will be clearly understood by those of ordinary skill in the art from the above description of the JPEG picture encoding device 100 and thus a detailed description thereof will be omitted for simplicity.

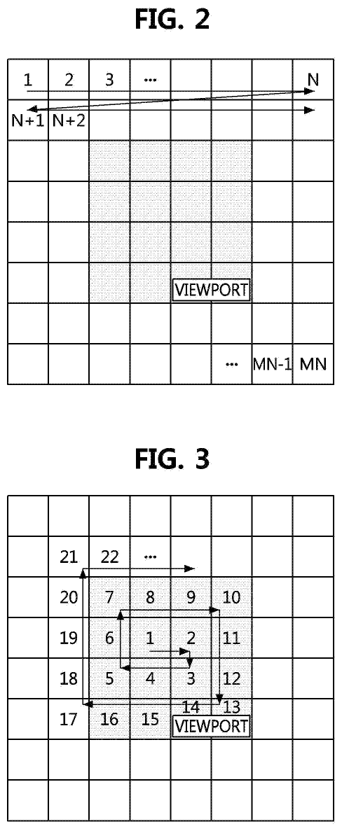

FIG. 2 is a typical block ordering scheme.

The picture encoding device may divide one picture into at least one block having a predetermined size and compress each of the at least one block as illustrated in FIG. 1. Here, the predetermined size may include an 8×8 pixel size, but is not limited thereto.

The compression of each of the at least one block may be performed sequentially according to a predetermined ordering scheme (hereinbelow, referred to as “block ordering” or “block ordering scheme”). Generally, a conventional picture encoding device sequentially compresses a plurality of blocks according to a raster scan order. Here, the raster scan order may refer to an order that a plurality of blocks are processed in an order from a upper left block through a upper right block and a lower left block to a lower right block.

The raster scan order which is a conventional block ordering scheme will now be described with respect to a picture consisting of M×N blocks each having a predetermined size as an example for convenience of explanation. Here, M and N may be natural numbers greater than or equal to 1.

Referring to FIG. 2, the picture encoding device which compresses the blocks in the raster scan order may sequentially perform the compression for the blocks from a leftmost and uppermost block 1 to a rightmost and uppermost block N and then sequentially perform the compression for the blocks from a block (N+1) just below the leftmost and uppermost block 1 to a block just below the rightmost and uppermost block N. The picture encoding device may proceed to perform the compression in a similar fashion for the blocks in next rows until the compression of a rightmost and lowermost block MN is completed. Here, an index 1, 2, . . . , N, N+1, . . . , MN−1, and MN may refer to a sequence in which the blocks are compressed.

In other words, the picture encoding device may sequentially compress the blocks in a row from left to right, and sequentially compress the blocks in a first row, a second row, a third row, and a fourth row.

Recently, however, pictures having very large sizes or a large amount of picture data such as a panoramic pictures, a 360-degree picture, and a multi-view pictures (cloud point picture) have come into wide use. Such pictures may be generated by stitching a plurality of pictures observed in fields of view more than a field of view observable by human eyes.

In a service for transmitting and displaying such pictures, a viewport which is a partial picture corresponding to a most central field of view in the entire picture may be provided first to a user, and then the other partial pictures may be provided to the user according to a user input, for example, a cursor movement.

Here, the picture is provided to the user by decoding encoded picture data. However, the decoding of the encoded picture data is performed starting from a leftmost and uppermost block as in the encoding order, and thus a region of the picture irrelevant to the viewport provided to the user first is decoded first. This inconsistency may become serious when a network bandwidth is narrow or when a picture having a very large size is transmitted. The present disclosure progressively encodes and decodes a picture to address the problem.

FIG. 3 illustrates a block ordering scheme according to an embodiment of the present disclosure.

A progressive picture encoding method according to an embodiment of the present disclosure sequentially encodes the blocks included in a picture in a spiral order from a block in a center to a block neighboring an edge (hereinbelow, referred to as “center-to-edge order”).

When there is information regarding a viewport which is a partial region of the picture corresponding to the field of view or a line of sight of the view, the center may refer to one of at least one block included in the viewport. In particular, the center may refer to a central block among the at least one block included in the viewport. When there is no information regarding the viewport, the center may refer to a block disposed in a center of the picture and having a predetermined size. Here, the at least one block included in the viewport or may be referred to as a central region. The center may refer to a center block or a block closest to the center in the central region.

The edge may refer to an outer side or border of the picture but is not limited thereto, and should be understood as a term used to indicate a direction outward from the center.

According to an embodiment of the present disclosure, an order from the center to the edge may include a clockwise or counterclockwise spiral order from the center to the edge. For a detailed description, it is assumed that the viewport includes sixteen (4×4) blocks at the center of the picture.

Referring to FIG. 3, in an embodiment of the present disclosure, one of the sixteen blocks included in the viewport may be chosen as the center and determined as a first block 1 to be encoded first. Then, a block located to the right of the first block 1 may be determined as a second block 2 to be encoded, and a block located below the second block 2 may be determined as a third block 3 to be encoded. According to an embodiment of the present disclosure, the encoding order for the blocks may continue to be determined following a clockwise spiral path from the center to the edge.

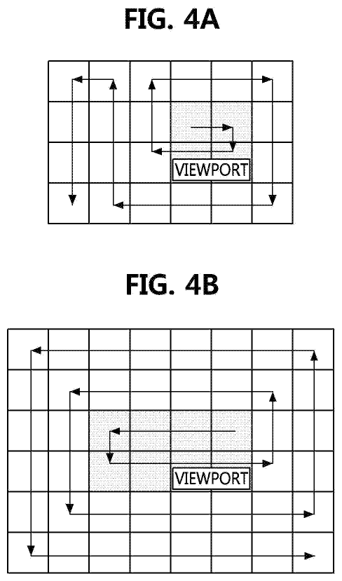

The center-to-edge order according to an embodiment of the present disclosure may include the encoding order of the blocks that may be determined as described above, but is not limited thereto and may generally mean an order of encoding and decoding blocks of a picture such that major regions in the picture such as a central viewport or a region-of-interest (ROI) are first encoded or decoded and the other regions are encoded and decoded later. According to the center-to-edge order, adjacent blocks may be ordered to be processed consecutively. Though adjacent blocks may be ordered to be processed inconsecutively when there are a plurality of major regions in the picture or because of other circumstances, the blocks may be ordered such that the discontinuities are minimized. Therefore, the center-to-edge order may vary according to the size, shape, and type of the picture, the position of the viewport, and the positions and number of the ROIs. Examples of the center-to-edge order related to several circumstances will be described with reference to FIGS. 4 to 6.

FIGS. 4A and 4B illustrate block ordering schemes for a rectangular picture block according to embodiments of the present disclosure.

Referring to FIGS. 4A and 4B, when the picture is a rectangle, a center-to-edge order according to an embodiment of the present disclosure may be determined such that orders of the blocks are determined following a clockwise or counterclockwise spiral path starting from a central block among the at least one block included in the viewport to the edge. Further, the center-to-edge order may be determined such that the orders of the remaining blocks are consecutive. Here, the shape of the viewport is not limited to a square, but the viewport may have a rectangular shape.

In other words, the picture encoding device subject to the center-to-edge order according to an embodiment of the present disclosure may determine the orders of the blocks along a clockwise or counterclockwise spiral path with respect to the viewport of the picture, and may additionally determine the orders of all the remaining blocks to be consecutive from a last block in the spiral path. Such an order scheme may not be limited by the shape of the viewport.

Referring to FIG. 4A, the center-to-edge order according to an embodiment of the present disclosure in case that the picture is rectangular and the viewport is a square is determined as follows.

According to the center-to-edge order, the orders of the blocks may be determined such that the orders of the blocks in the square viewport may be determined first along a clockwise spiral path starting from one block included in the square viewport, and then the orders of the blocks outside the viewport may be determined along the same clockwise spiral path. Since the picture is rectangular, however, the setting of the order along the spiral path results in remaining blocks of which orders are not determined.

The determination of the orders for all the remaining blocks may vary according to the position of the viewport in the picture. For example, the orders of the remaining blocks may be determined, starting from a last block of which order is determined along the spiral path, in an order to select an upper block, an upper block, an upper block, a left block, a lower block, a lower block, and a lower block as shown in FIG. 4A. Alternatively, the orders of the remaining blocks may be determined, starting from a last block of which order is determined along the spiral path, in an order to select a left block, an upper block, an upper block, an upper block, a right block, a lower block, and a lower block. However, the disclosure is not limited thereto.

FIG. 4B illustrate a block ordering scheme when the picture is rectangular and the viewport is rectangular also.

According to the center-to-edge order, the orders of the blocks may be determined such that the orders for the blocks in the square viewport may be determined first along a counterclockwise spiral path starting from one block included in the square viewport, and then the orders for the blocks outside the viewport may be determined along the same counterclockwise spiral path.

Here, the counterclockwise spiral path is not limited to a square spiral path and may include a rectangular spiral path as shown in FIG. 4B. In this case, the remaining blocks shown in FIG. 4A may not be present.

FIGS. 4A and 4B just show examples of the center-to-edge order according to the embodiment of the present disclosure when the picture is rectangular, and the scope of the present disclosure is not limited to the shape of the picture or the shape of the viewport described above.

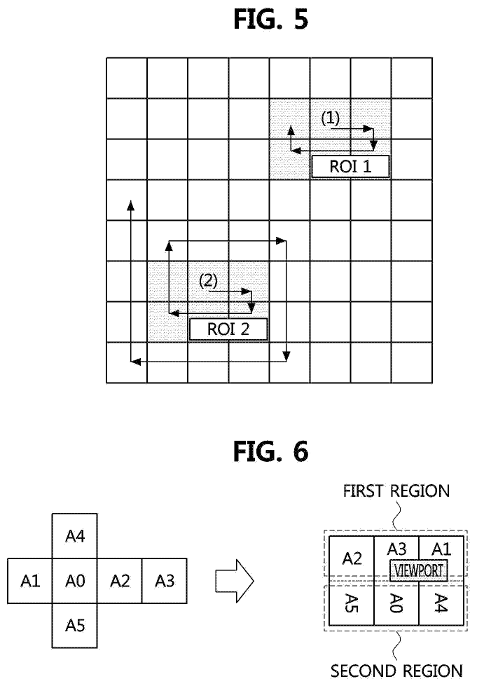

FIG. 5 illustrates a block ordering scheme for a picture having two ROIs according to an embodiment of the present disclosure.

Referring to FIG. 5, when the picture includes two ROIs, the center-to-edge order according to an embodiment of the present disclosure may be determined with respect to each of the two ROIs. The order for the remaining blocks which are not included in the two ROIs may be determined to be extended from the center-to-edge order for one of the two ROIs.

In other words, the picture encoding device subject to the center-to-edge order according to the embodiment of the present disclosure may determine the orders of blocks included in a first ROI along a clockwise or counterclockwise spiral path starting from a central block of the first ROI and determine the orders of blocks included in a second ROI along a clockwise or counterclockwise spiral path starting from a central block of the second ROI.

Subsequently, the picture encoding device subject to the center-to-edge order may additionally determine the orders all the remaining blocks along the spiral path for one of the two ROIs consecutively from a last block of which order is determined in the ROI. In other words, after the orders of the blocks included in each of the first and second ROIs are determined, the orders of the remaining blocks of the picture may be determined to be consecutive from the last block of the first ROI of which order was determined along the spiral path or may be determined to be consecutive from the last block of the second ROI of which order was determined along the spiral path.

FIG. 5 just shows an example of the center-to-edge order according to the embodiment of the present disclosure when the picture includes two ROIs, and thus the scope of the present disclosure is not limited thereto.

FIG. 6 illustrates a block ordering scheme for a 360-degree picture according to an embodiment of the present disclosure.

Referring to FIG. 6, a center-to-edge order in case of a 360-degree picture may be determined with respect to cube map projection images of the 360-degree picture. Since the center-to-edge order may be determined for the 360-degree picture which may be converted to a shape other than a simple rectangular shape as well as a planar picture having a rectangular shape obtained from the 360-degree picture, the center-to-edge order is not limited to a rectangular picture.

When the 360-degree picture is converted into cube map projection images, a first region consisting of faces A2, A3, and A1 and a second region consisting of faces A4, A0, and A5 are consecutive pictures, respectively, but may be non-consecutive with each other. The center-to-edge order according to an embodiment of the present disclosure first may determine the order of the blocks in a region including a viewport between the two regions, and then determine the order of the blocks in another region which does not include viewpoint.

In detail, the picture encoding device subject to the center-to-edge order according to an embodiment of the present disclosure may determine the orders of blocks consecutively from a central block among blocks included in the viewport to an outer side or edge of the first region including the viewport among the two regions, and then determine the orders of blocks in the second region which is the remaining region. Here, a last block determined in the first region and a first block determined in the second region may not be consecutive to each other, but the present disclosure is not limited thereto.

FIG. 6 just shows an example of the center-to-edge order according to the embodiment of the present disclosure in the case of the 360-degree picture, and thus the scope of the present disclosure is not limited thereto.

Referring to FIGS. 4 to 6, the center-to-edge order according to embodiments of the present disclosure first determines the orders of the blocks in the viewport or the ROI of the picture and then consecutively determines the orders of the blocks which are not included in the viewport or the ROI. However, the order may be determined to be continuous between adjacent blocks but may be determined, when there are adjacent blocks on which the orders cannot be determined to be consecutive, such that such discontinuities may be minimized.

FIG. 7 illustrates a block ordering scheme for a moving picture according to an embodiment of the present disclosure.

The center-to-edge order according to an embodiment of the present disclosure is applicable not only to an encoding of a still picture but also to an encoding of a video or a moving picture.

The method of encoding the moving picture may further include operations of a prediction, a subtraction, and so on compared to the method of encoding the still picture. The prediction operation may refer to an operation of generating a prediction block by predicting a current block to be encoded through an intra frame prediction or an inter frame prediction, and the subtraction operation may refer to an operation of generating a residual block by subtracting the prediction block from the current block. In the prediction operation, the prediction block may be generated through the intra frame prediction or the inter frame prediction for each of a plurality of frames in a picture, but an embodiment of the present disclosure will be described below with respect to an I-frame, as an example, for which the intra frame prediction is performed.

A conventional method of encoding the video or the moving picture generates the prediction block through various prediction modes on the basis of at least one of a left block, a upper block, and a upper left block of the current block to be encoded in a frame. The reason of using at least one of the left block, the upper block, and the upper left block of the current block while generating the prediction block is because such blocks are encoded and decoded earlier than the current block according to the raster scan order.

However, since a method of encoding the video or the moving picture according to an embodiment of the present disclosure is subject to the center-to-edge order in which the encoding order is determined along a clockwise or counterclockwise spiral path from a center of the picture to the outer side of the picture, the prediction block of the current block to be encoded may be generated on the basis of blocks adjacent to the current block among previously encoded blocks.

In other words, the basis for generating the prediction block of the current block is not fixed to at least one of the left block, the upper block, and the upper left block of the current block. Instead, the prediction block may be generated on the basis of at least one block encoded or decoded previously among the left block, the upper block, the upper left block, a right block, a upper right block, a lower block, a lower left lock, and a lower right block.

Referring to FIG. 7, the device for encoding the video or the moving picture according to an embodiment of the present disclosure may encode blocks according to numbers denoted on the blocks, for example. While generating the prediction block for a fourth block 4, the encoding device may use at least one of a first block 1, a second block 2, and a third block 3 which are previously encoded and adjacent to the fourth block 4. Also, while generating the prediction block for a tenth block 10, the encoding device may use at least one of a ninth block 9 and the second block 2 which are previously encoded and adjacent to the tenth block 10.

In other words, the method of encoding or decoding the video or the moving picture according to an embodiment of the present disclosure may additionally define and use at least one prediction mode to generate the prediction block using the blocks which are adjacent to the current block and have been encoded prior to the current block.

FIG. 8 is a block diagram of a picture encoding device according to an embodiment of the present disclosure.

Referring to FIG. 8, the picture encoding device 800 according to an embodiment of the present disclosure may include at least one processor 810, a memory 820, and a storage device 830. The picture encoding device 800 according to an embodiment of the present disclosure may be installed in a general picture encoding device or separately prepared and connected to the general picture encoding device, but the present disclosure is not limited thereto.

The processor 810 may execute program commands or instructions stored in the memory 820 and/or the storage 830. The processor 810 may be a central processing unit (CPU), a graphics processing unit (GPU), or a dedicated processor suitable for performing the methods of the present disclosure. The memory 820 and the storage 830 may include a volatile storage medium and/or a non-volatile storage medium. For example, the memory 820 may include a read-only memory (ROM) and/or a random access memory (RAM).

The memory 820 may store at least one instruction to be executed by the processor 810. The at least one instruction may include an instruction for obtaining information regarding a central region of the picture, an instruction for selecting an initial block from at least one block included in the central region, an instruction for determining a coding path for encoding a plurality of blocks included in the picture in a center-to-edge order starting from the initial block, and an instruction for encoding the picture on the basis of the coding path.

The central region may include a region of the picture corresponding to a line of sight of a user or a central region of the picture having a predetermined size.

The instruction for selecting the initial block from the at least one block included in the central region may include an instruction for selecting, as the initial block, a block located closest to a center of the central region among the at least one block included in the central region.

The instruction for determining the coding path for the plurality of blocks included in the picture in the center-to-edge order starting from the initial block may include an instruction for determining the coding path for the plurality of blocks included in the picture along a clockwise or counterclockwise spiral path starting from the initial block.

The instruction for determining the coding path for the plurality of blocks included in the picture along the clockwise or counterclockwise spiral path starting from the initial block may include an instruction for determining the coding path for at least one remaining block which is not included in the coding path determined along the spiral path starting from a last block included in the coding path when there is at least one remaining block among the plurality of blocks.

The instruction for determining the coding path for the at least one remaining block may include an instruction for determining the coding path for the at least one remaining block to minimize a number of discontinuity in the coding path between adjacent blocks among the at least one remaining block.

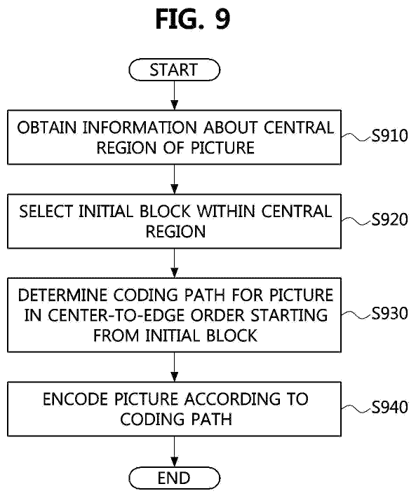

FIG. 9 is a flowchart showing a picture encoding method according to an embodiment of the present disclosure.

Referring to FIG. 9, the picture encoding device according to an embodiment of the present disclosure may obtain information about a central region of a picture (S910). Here, the central region may refer to a viewport which is a region of the picture corresponding to a user's line of sight when the viewport is present and may refer to a region in the center of the picture having a predetermined size when there is no viewport. Also, the central region may refer to an ROI when there is at least one ROI, but the present disclosure is not limited thereto.

The picture encoding device may select an initial block within the central region (S920). The initial block may be a block located at or closest to the center of the central region among at least one block included in the central region or may be arbitrarily selected, but present disclosure is not limited thereto.

Subsequently, the picture encoding device may determine a coding path for a plurality of blocks included in the picture in the center-to-edge order starting from the initial block (S930) and may encode the picture on the basis of the coding path (S940).

Here, the center-to-edge order may refer to an order in which encoding is performed from the center of the picture to an outer side or edge thereof along a clockwise or counterclockwise spiral path from the initial block to the outer side or edge of the picture. In other words, the coding path may be determined along a spiral from the initial block to the outer side or edge of the picture.

In case that there is any block in the picture that cannot be included in the coding path during the determination of the coding path along the spiral path because the picture is rectangular or there are multiple central regions, a coding path for remaining blocks which are not included in the determined coding path may be determined to continue from a last block included in the coding path determined. The coding path may or may not be continuous but may be determined such that the number of discontinuities is minimized, which was described above with reference to FIGS. 4-6 and detailed description thereof will be omitted.

Operations according to embodiments of the present disclosure can be embodied as a computer-readable program or code in a computer-readable recording medium. The computer-readable recording medium includes all types of recording media storing data readable by a computer system. The computer-readable recording medium may be distributed over computer systems connected through a network so that a computer-readable program or code may be stored and executed in a distributed manner.

The computer-readable recording medium may include a hardware device specially configured to store and execute program commands, such as ROM, RAM, and flash memory. The program commands may include not only machine language codes such as those produced by a compiler, but also high-level language codes executable by a computer using an interpreter or the like.

Some aspects of the present disclosure have been described above in the context of a device but may be described using a method corresponding thereto. Here, blocks or the device corresponds to operations of the method or characteristics of the operations of the method. Similarly, aspects of the present disclosure described above in the context of a method may be described using blocks or items corresponding thereto or characteristics of a device corresponding thereto. Some or all of the operations of the method may be performed, for example, by (or using) a hardware device such as a microprocessor, a programmable computer or an electronic circuit. In some embodiments, at least one of most important operations of the method may be performed by such a device.

In embodiments, a programmable logic device (e.g., a field-programmable gate array) may be used to perform some or all of functions of the methods described herein. In embodiments, the field-programmable gate array may be operated with a microprocessor to perform one of the methods described herein. In general, the methods are preferably performed by a certain hardware device.

While the present disclosure has been described above with respect to embodiments thereof, it would be understood by those of ordinary skill in the art that various changes and modifications may be made without departing from the technical conception and scope of the present disclosure defined in the following claims.

What is claimed is:

1. A method of progressively encoding a picture, comprising:
obtaining information regarding a central region of the picture;
selecting an initial block from at least one block included in the central region;
determining a coding path for encoding a plurality of blocks included in the picture in a center-to-edge order starting from the initial block; and
encoding the picture on the basis of the coding path.

2. The method of claim 1, wherein the central region comprises a region of the picture corresponding to a line of sight of a user or a central region of the picture having a predetermined size.

3. The method of claim 1, wherein selecting the initial block from the at least one block included in the central region comprises:
selecting, as the initial block, a block located closest to a center of the central region among the at least one block included in the central region.

4. The method of claim 1, wherein determining the coding path for the plurality of blocks included in the picture in the center-to-edge order starting from the initial block comprises:
determining the coding path for the plurality of blocks included in the picture along a clockwise or counterclockwise spiral path starting from the initial block.

5. The method of claim 4, wherein determining the coding path for the plurality of blocks included in the picture along the clockwise or counterclockwise spiral path starting from the initial block comprises:
when there is at least one remaining block which is not included in the coding path determined along the spiral path among the plurality of blocks, determining the coding path for the at least one remaining block starting from a last block included in the coding path.

6. The method of claim 5, wherein determining the coding path for the at least one remaining block comprises:
determining the coding path for the at least one remaining block to minimize a number of discontinuity in the coding path between adjacent blocks among the at least one remaining block.

7. A device for progressively encoding a picture, comprising:
a processor; and
a memory storing at least one instruction to be executed by the processor,
wherein the at least one instruction when executed by the processor causes the processor to:
obtain information regarding a central region of the picture;
select an initial block from at least one block included in the central region;
determine a coding path for encoding a plurality of blocks included in the picture in a center-to-edge order starting from the initial block; and
encode the picture on the basis of the coding path.

8. The device of claim 7,
wherein the central region comprises a region of the picture corresponding to a line of sight of a user or a central region of the picture having a predetermined size.

9. The device of claim 7, wherein the at least one instruction when executed by the processor causes the processor to:
select, as the initial block, a block located closest to a center of the central region among the at least one block included in the central region.

10. The device of claim 7, wherein the at least one instruction when executed by the processor causes the processor to:
determine the coding path for the plurality of blocks included in the picture along a clockwise or counterclockwise spiral path starting from the initial block.

11. The device of claim 10, wherein the at least one instruction when executed by the processor causes the processor to:
when there is at least one remaining block which is not included in the coding path determined along the spiral path among the plurality of blocks, determining the coding path for the at least one remaining block starting from a last block included in the coding path.

12. The device of claim 11, wherein the at least one instruction when executed by the processor causes the processor to:
determine the coding path for the at least one remaining block to minimize a number of discontinuity in the coding path between adjacent blocks among the at least one remaining block.
